(19) United States
(12) Patent Application Publication
(10) Pub. No.: US 2005/0234811 A1
(43) Pub. Date: Oct. 20, 2005

(54) Method and system for virtual sealed-bid competitions held over a communications network

(76) Inventors: Joseph A. Herman, Springfield, MO (US); Darren C. Henderson, Springfield, MO (US); Erick L. Burgess, Springfield, MO (US)

Correspondence Address: Jonathan A. Bay;Attorney at Law, Ste. 314, 333 Park Central East, Springfield, MO, 65806, US

(21) Appl. No.: 11/126,957

(22) Filed: May 11, 2005

Related U.S. Application Data
(63) Continuation of application No. 09/649,400, filed on Aug. 26, 2000.
(63) Continuation-in-part of application No. 09/511,431, filed on Feb. 23, 2000, now abandoned.
(60) Provisional application No. 60/203,964, filed on May 12, 2000.
(60) Provisional application No. 60/169,044, filed on Dec. 4, 1999.
(60) Provisional application No. 60/121,347, filed on Feb. 24, 1999.

(51) Int. Cl. G06F 17/60

(52) U.S. Cl. 705/37

(57) ABSTRACT

A computer-implemental method of transacting a sealed bid competition has deadline-assurance process which in part upholds the integrity of the sealed bid competition. In a sealed bid competition, a buyer originates a “request for bid” communication that specifies bid items as well as includes a parameter of deadline. Participating vendors respond with “response” communications that contain substantive content presumptively responsive to the “request for bid” communication. The object of a sealed bid competition is to keep everyone, including especially the buyer, blind to the bid responses of everyone else until after the deadline. The deadline-integrity process has the buyer either precluded from access to the “response” communications until the deadline or else has the buyer's activity with accessing the “response” communications is logged so that such log record can thereafter disclose if the buyer voluntarily restrained itself from accessing the “response” communications until after the deadline.

### CROSS-REFERENCE TO RELATED APPLICATION

A portion of the disclosure of this patent document and/or the provisional application(s) that provide a priority basis for this patent document contain(s) material which is subject to copyright protection. The copyright owner(s) has(have) no objection to facsimile reproduction by anyone of the patent document or the patent disclosure, or the matters in the file(s) comprising the prosecution history of this patent document, as any of the foregoing appears with Patent & Trademark Office files or records, but otherwise reserve(s) all copyright rights whatsoever.

This non-provisional application is a continuation of U.S. patent application Ser. No. 09/649,400, filed Aug. 26, 2000, which claims the benefit of U.S. Provisional Patent Application No. 60/203,964, filed May 12, 2000; and which non-provisional application, in parallel to the provisional application, is also a continuation-in-part of U.S. patent application Ser. No. 09/511,431, filed Feb. 23, 2000, which claims the benefit of U.S. Provisional Patent Application No. 60/169,044, filed Dec. 4, 1999, and U.S. Provisional Patent Application No. 60/121,347, filed Feb. 24, 1999.

### BACKGROUND OF THE INVENTION

1. Field of the Invention

The invention relates sealed-bid competitions and more particularly to implementation of virtual or “Internet” sealed-bid competitions.

2. Prior Art

Many organizations are either required to or else choose to purchase by the bid process. Such organizations include without limitation public and private school systems, colleges and universities, municipalities, public utilities, non-profit organizations, and all other manner of public or private businesses and/or local, state and federal agencies.

Such processes are initiated by a buyer issuing a request document. Vendors reply by submission of some form of response document. In the industry, such buyer request documents are variously known as Request for Bid, Request for Quote, Request for Price, Request for Information and so on.

A specialized case of bid process is known as the “sealed-bid” process or competition. Typically the sealed-bid process is initiated by the buyer issuing a request document which might again be simply referred to as a “Request for Bid,” the responding-bidder's response to which is sent “sealed,” or that is, as in a sealed envelope. The sealed-bid competition is a rule-structured process utilized by, for example and without limitation, governmental entities, and is carried out in accordance with such established rules.

A representative sealed-bid competition might include the following activities. A buyer writes out a form or document which is typically called a “Request for Bid” (hereinafter often times but not always abbreviated to “R.F.B.”). The “Request for Bid” is completed in replicate and distributed to each vendor appearing on an address list therefor. The participating vendors respond with a “sealed bid.” That is, the vendors respond by writing down their best price. Also the vendors return their response or bid “sealed,” as in, eg., a sealed envelope. A fairly uniform characteristic of the sealed-bid competition includes the opening or unsealing date and time. That is, all participating vendors submit their sealed bids such that they are supposed not to know the prices in any other's bid. All the returned bids are held and not opened or unsealed until the appointed unsealing date. At the appointed time and date, all the returned bids are then indeed unsealed and “read publicly aloud” (eg., published), and evaluated concurrently for sake of determining a winner. All things being equal, the winner generally is the vendor with the lowest price. The buyer is then in position to bestow an award to the winner.

Typically the rules governing such procedures require the buyer to publish the bid competition results. Publication of the results facilitates, among other ways, allowing interested parties to assess whether the bid process was conducted in a principled manner and in accordance with established rules or in view of other objective standards of fairness.

A noteworthy aspect of the foregoing is the “sealing” and “unsealing” of the bids. Evidently this practice was established to accommodate various notions of fair play. The generally accepted rules require that the collective “sealed” bids of the participating vendors be kept “sealed” until the appointed opening or “unsealing” date. Hence such rules disallow a given vendor from knowingly bidding lower than another vendor's previously submitted bid through unauthorized knowledge of the other vendor's bid. The sealed-bid process is abused if a later-entering vendor gets unauthorized knowledge of an earlier-entering vendor's bid. The later-entering vendor can use that unauthorized knowledge to produce an un-permitted competitive bid. Among other times when the earlier-entering vendor's bid is vulnerable to unauthorized disclosure is, when the sealed-bid is returned to the buyer.

Let's examine this in light of the present day paradigm with paper documents. A buyer indeed possesses all the vendor's “sealed-bid” envelopes before the deadline. The buyer is trusted to honor the deadline and not unseal any of the envelopes until the unsealing event or the deadline passes or the like. If after the unsealing event a losing vendor cries foul, there's little evidence to support the truth or falsity of a charge that the buyer peeked into the sealed-bids early and leaked out that information. The envelopes are now opened. Any investigator would find it difficult to prove an envelope shows signs of tampering inconsistent with being opened at the unsealing event.

Let's say a vendor alleges to the community (vis-a-vis through the press) that a given buyer is holding dirty sealed-bid competitions. The dearth of evidence to prove or disprove the allegation hurts the sealed-bid process as a whole. The vendor community seeks to have office abusers uncovered and prosecuted. The public seeks assurance that its tax-spending officers are trustworthy. And no doubt, the impugned buyer seeks exoneration. It is a shortcoming of the prior art way which sealed-bid processes are conducted that, there isn't better assurance the returned bids aren't tampered with and/or peeked into.

The background of the invention having been described thus far by everything previously, pause can be taken to insert the reflections of one of the inventors hereof, who has 26 years experience in the public purchasing field. It has been spent with a public school district in Southern Missouri nowadays encompassing a population of about a quarter million. He relates the following brief points about what this career has been like.

As a matter of background, the public school districts in Missouri are empowered by the State to collect taxes for themselves, subject to among other conditions, that the school districts follow set procedures for purchasing. Briefly stated, purchases greater than $2,000 must be solicited by sealed-bid competitions, purchases between $500 and $2,000 require the solicitation of at least three bids, and purchases less than $500 may be bid or simply just bought. Solicitation of bids in the low end of the range can be as informal as telephone calls, so long as the “purchasing agent” keeps a telephone log.

Bid procedures vary, generally there being the biggest differences between bid solicitations for construction projects versus purchases for about anything else. With construction projects, the solicitation for bid is written and then, instead of being sent directly to prospective contractors, it is legally advertised. Interested parties must apply for the bid solicitation and either post a bid bond or deposit a cashiers check or the like. Hence that is how the bid parties are gotten. When the bid responses are returned in time for the bid opening or “unsealing,” the bids are read publicly aloud. Generally all the bidding parties will be in attendance. Then in some later time frame, say ten days or so, the purchasing agent delivers the decision. All the bid parties are entitled to copies of the results.

With bid solicitations for vendable things other than construction (eg., commodities or other services and so on), the purchasing agent presumptively already has a standing vendor list. Most times, vendors approach the purchasing agent about getting enrolled on the vendor lists. In some cases, the purchasing agent might solicit a worthy party to get itself on the vendor list. However the vendor list is gotten, the purchasing agent writes (or oversees the generation of) a bid solicitation. The solicitations are sent directly to the applicable vendors on the vendor list. A party not on the original vendor list has time, after the solicitations have been sent, to get in on the bidding before the close date. Then as described above, on the appointed date and time for reading the bids aloud, the bids are indeed read aloud to whatever public audience may appear. In some later time frame, say ten days or so, the decision will be made.

The actual codified rules governing bid solicitations are typically adopted and modified from any of the various model codes that are offered by various national organizations. For example, the public sector is likely to follow the model rules of the N.I.G.P. (“National Institute for Government Purchasing”) or else, at least in this state, the M.A.P.P. version thereof (ie., “Missouri Association for Public Purchasing”). The private sector is more likely to follow what's produced by the N.A.P.M. (“National Association for Purchasing Managers”).

In the latter years, this inventor has served the school district as the purchasing agent. Last year (1999), this school district issued about 700 bid solicitations, anywhere upwards from the $500 floor to the highest that fell somewhere around (in round numbers) about $1,000,000 (1 million dollars). The mean value of this mix was likely $10,000, but more significantly, only about 200 of the 700 bid solicitations were in fact sealed bid competitions. By implication, the majority of the bid solicitation involved amounts between about $500 and $2,000. Hence the bid solicitations for the amounts of less than $10,000 suck up disproportionately the time and resources of the purchasing agent and his staff that supports the purchasing operation.

Generating bid solicitations by paper has been cumbersome. The purchasing agent used to decide if to hold requisitions (eg., from teachers, warehouse and so on) and collect like requisitions to batch together, or let an individual requisition go at once. That decision was influenced by whether the purchasing agent might wish to avoid a sealed-bid competition. Again, if the requisition was for between $500 and $2,000, the purchasing again could avoid a sealed-bid competition. But if the purchasing agent held a requisition back to combine with others, and the aggregate amount breached $2,000, then a sealed-bid competition was mandated. Regardless which kind of bid solicitation process was followed, the purchasing agent attended to the generation and distribution of the bid solicitation to the vendors on the intended addressee list. In this written description, “bid solicitations” have been predominantly referred to as “requests for bid,” however in the industry there are various other names for the communication, and these names have been given previously.

In cases of mailed/sent out bid solicitations, the participating vendors are given til a closing date to get responses in. Usually this is the end of business hours on some given day. In the cases of sealed bid competitions, the responses are held without being opened until the appointed opening or “unsealing” date and time. This culminates in an event which, to at least the uninitiated, seems bizarre. The bids are unsealed in front of a public audience—the public sometimes giving this a miss, in which case the show is put on in front of an empty house—and read aloud. The inventor who has been a purchasing agent has these experiences to share about the “reading aloud” event.

Last year (1999), for the construction project that went for about $1 million dollars or so, a representative for each responding contractor was in attendance. In another instance, dealing with a copier lease contract for substantial value, the bid solicitation was sent to 17 vendors, 10 responded but three of those were no-bids, and so that left seven in the competition. Each of those seven vendors attended the “reading aloud” event. In contrast to those two examples, many times when the sealed bid competition involved just something over the $2,000 cut-off, none of the bidders would even bother to attend. On those occasions, the purchasing agent steps through the paces all the same, and “reads aloud” the bids to his assistant, who's there for recording the event. The few times when a vendor would attend the ^{˜}$2,000 or so competitions, it was virtually always a “new kid on the block” who hadn't quite yet come to trust the process. This “reading aloud” event, like the gavel falling in an auction, might be destined for extinction as the future sees the economy move over further into electronic modes of commerce. But to date it persists.

Following the “reading aloud” event, the audience (if any) goes away to await the purchasing agent's spreadsheet analysis of the results, and ultimate delivery of decision and publication of the results. The results can be challenged. Based on experience, challenges in this school district are rare. But a review process exists nonetheless. A requester might want to plead for a decision contrary to the purchasing agent's. The purchasing agent refers the matter to his boss, the business agent (who in this example is the school district treasurer and a member of the Board). If the requester remains unhappy after the business agent's findings, the next level of review is before the Board of Education itself.

Challenges are likely rare in part because the challenging vendor loses by just challenging. Such a challenge is sure to annoy the purchasing agent. A vendor who feels he or she has a supportable challenge may skip it nevertheless to avoid tacitly being blackballed in the future. Hence one aspect of the invention is to address this issue, and provide improvements in how sealed-bid competitions might be more trustworthily conducted than before.

To shift focus now to the other two inventors, these two younger inventors see things not from the vantage point of a buyer but as vendors. These two younger inventors share with each other a similar background in sales for a major retailer. From their viewpoint, most discussions to date about making the bid process more systematized have all been so buyer-centric, the vendors have largely been ignored. It is an object of the invention, unlike anyone else to date has been known to address, to truly expand a vendor's opportunities. Put differently, it is an object of the invention to increase a vendor's exposure to bid communications while decreasing the effort it takes to get at those bid communications.

From a vendor's viewpoint, the bid process is not simply cumbersome but plain onerous. There are substantial obstacles for any vendor to break into the market. To date, vendors who deal with public entities usually deal with just a limited number. Dealing with just a single public entity is a high maintenance task. To add larger numbers of public entities can overwhelm the worthwhileness of dealing with any. This has been the true experience of many vendors.

That is, vendors generally apply in person to get enrolled on a purchasing agent's vendor list. This entails introducing oneself to the purchasing agent of, say, the school district or public utility. All this “personal” side of doing business with purchasing agents is often overlooked. But in actuality, buyers are often guarded about who they'll deal with. For one, generating twenty bids has taken double the effort of doing ten. And doubling the vendor pool hasn't usually reaped twice the reward for doing so. Buyers are cautious with new persons because if and when the eventual mess-up occurs, the buyer wants to feel assured that there is a person to connect with the problem, a person who has presented him or herself as reputable and worthy for the task of solving the problem. Purchasing agents feel sufficiently stressed to misery as it is when things go more or less right. Why risk purchase orders on unknown factors who might just wreak misery in vengeance?

Often, after the awards in a bid competition, the losers feel that they lost based on intangibles not easily examined for fairness. In truth, purchasing agents value many intangible things including a known or projected reputation for curing problems. Purchasing agents might be accused of worrying the little things. But in an organization, the purchasing agent is valued not for ducking blame but bringing home the goods. In school, empty copiers need paper, not a purchasing agent's dodge. No doubt, after every competition, the buyer can cherry pick its awards. But sometimes, from the vantage of the losers, favoritism seems involved. The winner might appeared in the past to have curried favor with the purchasing agent in ways seeming to influence the purchasing agent's award decision.

### SUMMARY OF THE INVENTION

It is an object of the invention to provide a method and system to implement virtual or emulated, “Internet” sealed-bid mode competitions, with concentration on such aspects as relate to the trustworthiness thereof.

It is another object of the invention to deny buyers access to bid responses in such virtual or emulated sealed bid competitions until after the deadline.

It is alternate object of the invention, rather than deny buyers access to the bid responses, to provide records or logs of a given buyer's activity(ies) with the sealed bid responses in order to certify the buyer's faithfulness with its obligations.

It is an additional object of the invention to vindicate buyers when they feel their reputations have been impugned.

It is a further object of the invention to provide oversight or watchdog organizations with sufficient records, logs or evidence for such organizations to certify or not the proceedings.

It is a corollary object of the invention to have procurement events such as unsealing events or indeed complete emulated sealed-bid like competitions to be held wholly online by means of a web meeting process or the like.

These and other aspects and objects are provided according to the invention in a method of transacting a sealed bid competition over the Internet. The method comprises some of the following aspects. A buyer who is intending to purchase by a sealed bid competition is provided with a computer-implemented means for originating a “request for bid” communication. Such a communication preferably includes bid data as well as a parameter of deadline. An audience of vendors are permitted access to the “request for bid” communication. Preferably they gain such access by means of the Internet.

Those vendors which choose to respond by the deadline have a like computer-implemented utility for responding with “response” communications. These communications preferably contain substantive content presumptively responsive to the “request for bid” communication. Then buyer is next given with access to the “response” communications in its turn, also preferably by means of the Internet.

An inventive aspect relates to the provision of a deadline-integrity process. The process works such that either the buyer is precluded from access to the “response” communications until after the deadline, or else the buyer's activity with accessing the “response” communications is logged. That way, the log record can thereafter disclose if the buyer voluntarily restrained itself from accessing the “response” communications until after the deadline. Accordingly, the integrity of the sealed bid competition as transacted over the Internet is upheld at least in part by this sort of deadline-integrity process.

The deadline-integrity process can be implemented in various formats. For example, one format involves an intermediary Internet resource. The responding vendors commit their “response” communications to this intermediary Internet resource. That way, the intermediary Internet resource can either (i) preclude the buyer's access to at least the substantive content of the “response” communications until the lapse of some time determined from the deadline or (ii) log the buyer's activity with at least the substantive content of the “response” communications so that such log record can thereafter disclose if the buyer voluntarily restrained itself from accessing at least the substantive content of the “response” communications until the lapse of some time determined from the deadline.

The intermediary Internet resource can be include one or more Internet sites.

Another way of achieving respect for the deadline is to have the vendors' “response” communications to be encrypted such that decryption requires access to a specific decryption key. That way, the deadline-integrity process involves providing a trusted party with authority or control over the specific decryption key. Then, the trusted party can either (i) preclude the buyer's access to the decryption key until after the deadline or (ii) log the buyer's activity with the key so that such log record can thereafter disclose if the buyer voluntarily restrained itself from accessing the decryption key until after the deadline.

In this case, the trusted party can be an intermediary Internet resource, which may include the cooperation of one or more Internet sites.

In this next scenario, the “response” communications are encoded or compressed such that decoding or decompressing requires access to a specific decoding or decompressing object. The deadline-integrity process would again involve having a trusted party watch over the decoding or decompressing object. That way, the trusted party can either (i) preclude the buyer's access to the decoding or decompressing object until after the deadline or (ii) log the buyer's activity with the decoding or decompressing object so that such log record would disclose if the buyer voluntarily restrained itself from accessing said decoding or decompressing object until after the deadline.

The decoding or decompressing objects can be anything like a password, an algorithm, or hyper-link branch to an Internet address, and so on.

Another variant allows the log record to be committed to machines of the buyer's at the instance(s) of the buyer's accessing activities with respect to the “response” communications. While this is expedient, it is also partly undesirable because the log record could be vulnerable to unauthorized deletion, corruption or other manipulation, which would be hard to detect after the fact.

With any of the foregoing, the “request for bid” communication(s) can be contained in one or more web pages, even in a PowerPoint® presentation or the like, or in streaming media such as animation segments and so on. The concept of ‘lapse of some time determined from the deadline’ generally indicates a time concurrent with or later than the deadline.

Other aspects of the invention relate to how a given procurement event—such as a bid-unsealing event or a complete, emulated sealed-bid competition—can be transacted by means of a web-meeting process.

Consequently, a method using the Internet to transact an online, public unsealing event in a sealed bid competition preferably comprising the following steps. There is again a buyer that who is intending to purchase by a sealed bid competition and who is provided with a computer-implemented means for originating a “request for bid” communication. There are also a plurality of vendors having access to the “request for bid” communication by means of the Internet. Those vendors who choose to respond by the deadline do so by “response” communications. An intermediary Internet resource is provided to which the responding vendors commit the “response” communications.

An inventive aspect has the buyer using a web meeting resource by which the buyer holds the public unsealing event some time after the deadline for the sake of a real-time web-meeting audience. Presumptively this includes as at least the responding vendors.

The public unsealing event has the buyer accessing all the “response” communications—the buyer's preclusion to access being lifted by then—such that the content of which is available for viewing simultaneously by the web-meeting audience.

The web meeting resource is obtained from one or more Internet services that provide web conferencing and/or web collaboration utilities. The “request for bid” communication(s) can be contained in one or more web pages, even in a PowerPoint® presentation or the like, or in streaming media such as animation segments and so on. The activity of the buyer accessing all the “response” communications causes the content of which to be displayed in a spreadsheet, which is what can be viewed by the web-meeting audience.

Indeed, the web meeting service more advantageously allows the transaction of a complete procurement event over the Internet. Such a procurement event can emulates a sealed bid competition. This method involves the following activities.

A buyer who intends to purchase by a sealed-bid like competition gets access to a web meeting resource. Such a web meeting is to admit an audience comprising at least prospective vendors. The buyer originates a “request for bid” communication for publishing during the given web meeting session. The communication includes bid data as well as a parameter of deadline.

The vendors gain access to the “request for bid” communication during the given web meeting session. Those vendors which choose to respond by the deadline do so with one round of a “response” communication before the deadline. There is an intermediary Internet resource to which the responding vendors commit their “response” communications. The intermediary Internet resource precludes the buyer or any other party from accessing any “response” communication except one's own until some time after the deadline.

In one format, the vendors are made to respond occurs before the close of the given web-meeting session. In another, the original web meeting just allows the buyer to get out the “request for Bid” information, then the meeting closes.

If the procurement is held in accordance with the do-it-all in one meeting format, then before the close of the web-meeting session and after the deadline, the buyer might go ahead and finish up unfinished business by hosting then and there the unsealing event for the sake of the real-time web-meeting audience that has stayed on. Such a public unsealing event comprises the buyer accessing all the “response” communications—the buyer's preclusion to access being lifted by then—so that the content of which is available for viewing by all of the web-meeting audience.

The activity of the buyer accessing all the “response” communications causes the content of which to be displayed in a spreadsheet. The spreadsheet is at least some of what is viewed by the web-meeting audience. For the do-it-all in one meeting format, the buyer and any of the vendors may periodically check-in or -out of the given web-meeting session during its run.

The “request for bid” communication is preferably presented in web page format, such that publishing the comprises “request for bid” communication making the web page(s) of the buyer simultaneously displayable on the displays of the web-meeting audience. As an aside, the web meeting resource can comprise one or more Internet services providing the applicable web conferencing or web collaboration utilities.

Additional aspects and objects of the invention will be apparent in connection with the discussion further below of preferred embodiments and examples.

### BRIEF DESCRIPTION OF THE DRAWINGS

There are shown in the drawings certain exemplary embodiments of the screens for software in accordance with the invention as presently preferred. It should be understood that the invention is not limited to the embodiments disclosed as examples, and is capable of variation within the scope of the appended claims and/or the skills of persons having ordinary skill in the art to which the invention pertains. In the drawings,

FIG. 1a is a simplified schematic diagram showing various parties to a virtual sealed-bid competition in accordance with the invention, and as shown interconnected with one another by a communications network;

FIG. 1b is a TABLE tabulating various example ways BID responses from VENDOR(s) can be routed to the BUYER over the communications network;

FIG. 1c is a compilation of alternate embodiments in accordance with the invention for implementing virtual sealed bid competitions over the communications network;

FIG. 2a is an abbreviated document flow chart thereof as mainly from the perspective of a buyer, wherein a given vendor representative of a class of like vendors is included to show the ultimate destination and origin of various ones of the documents;

FIG. 2b is a document flow chart comparable to FIG. 2a except encompassing the perspectives of not just a buyer alone but also a central server as well as a class of like vendors enumerated as vendor¹, vendor², and so on, through vendorⁿ;

FIG. 2c is a document flow chart showing an computer-implemented form of “Request for Bid” in a buyer's machine, which after transmission to a vendor's machine is transformed into an computer-implemented form of “Response,” which after return to the buyer comes in as an computer-implemented form of “Bid” or the like; and,

FIG. 3 is a simplified schematic diagram showing a given procurement event in accordance with the invention, allowing an unsealing event or a complete, emulated sealed-bid competition to be transacted by means of a web-meeting process.

### DETAILED DESCRIPTION OF THE PREFERRED EMBODIMENTS

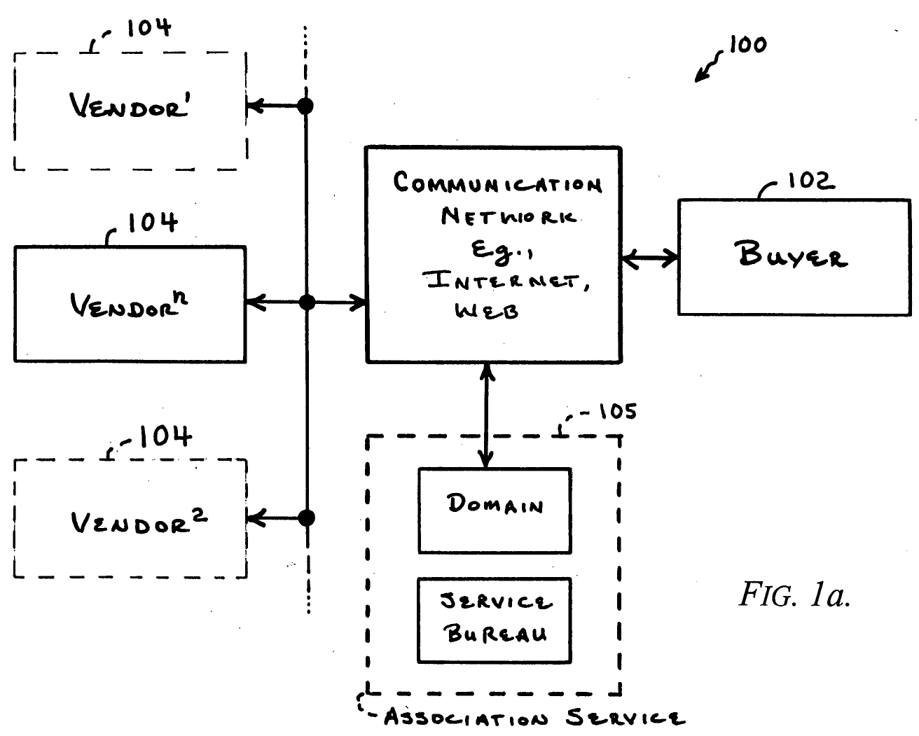

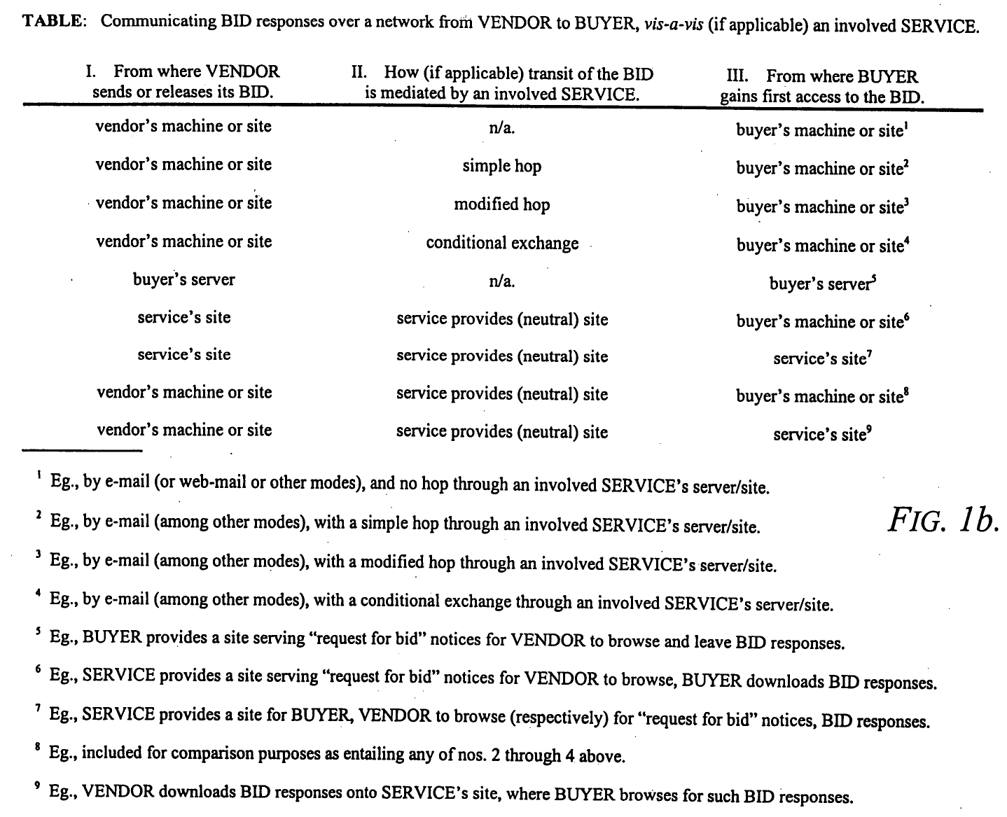

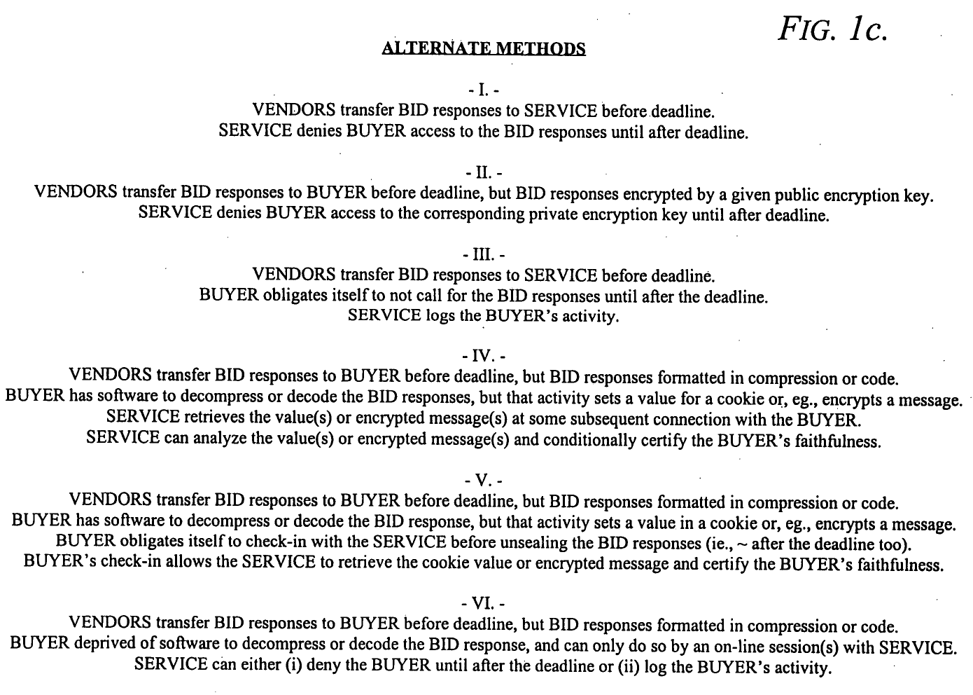

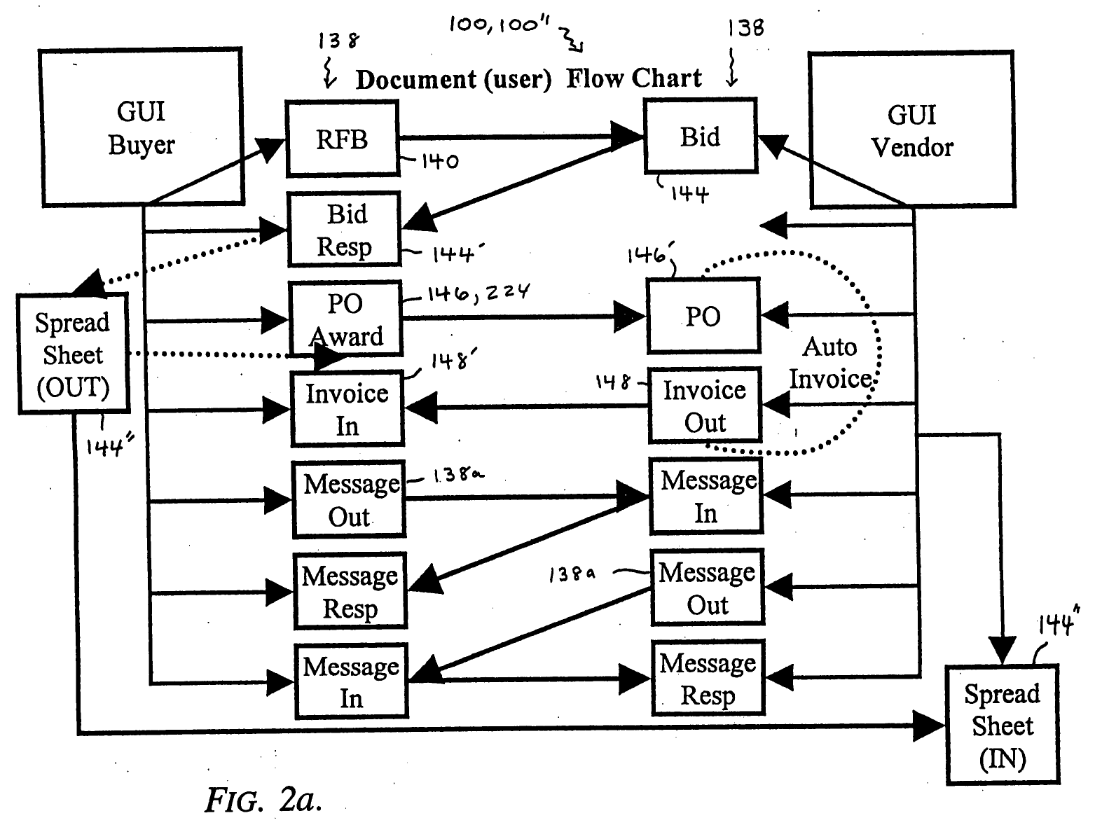

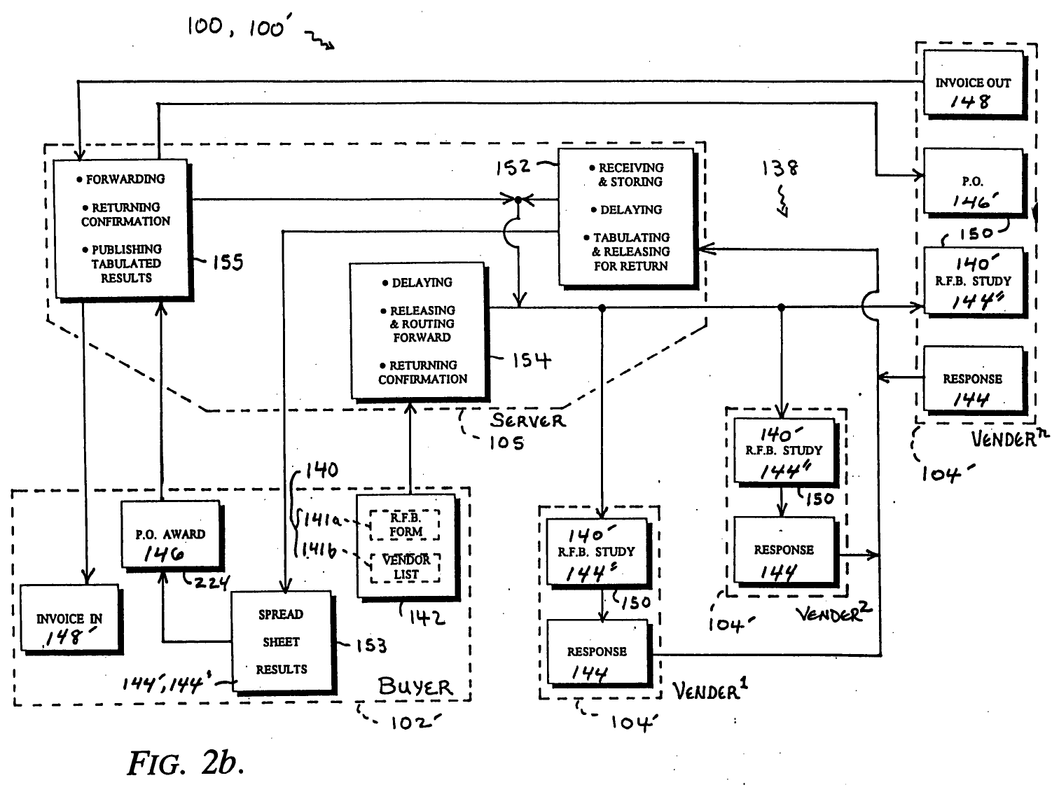

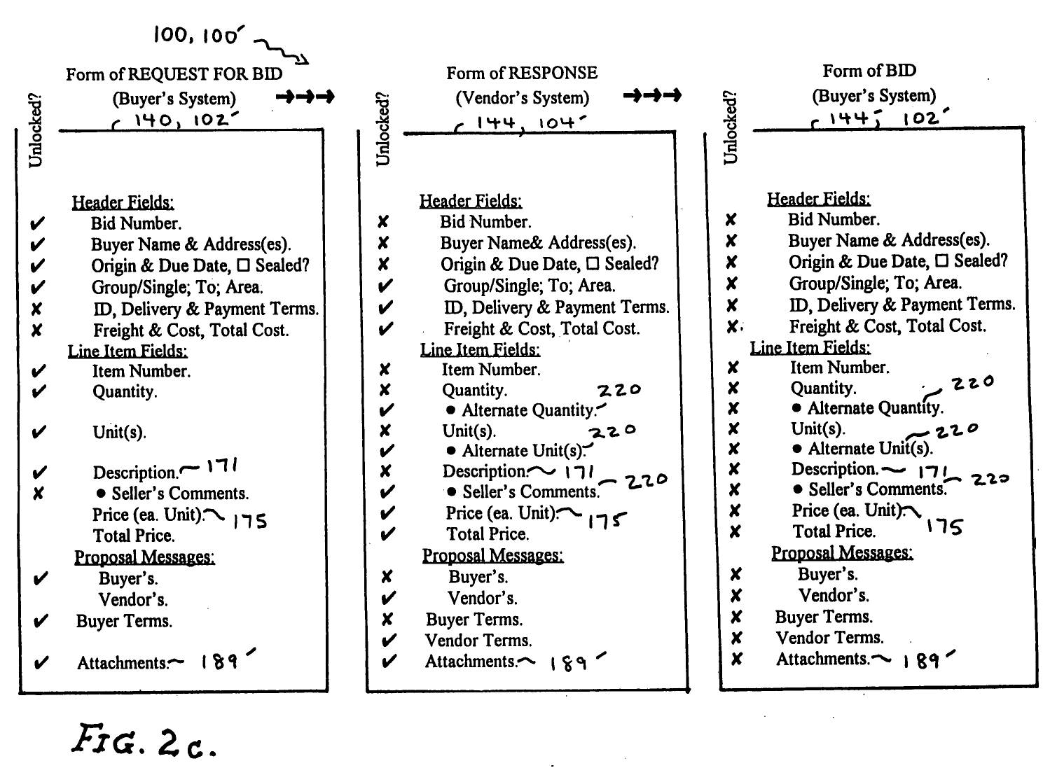

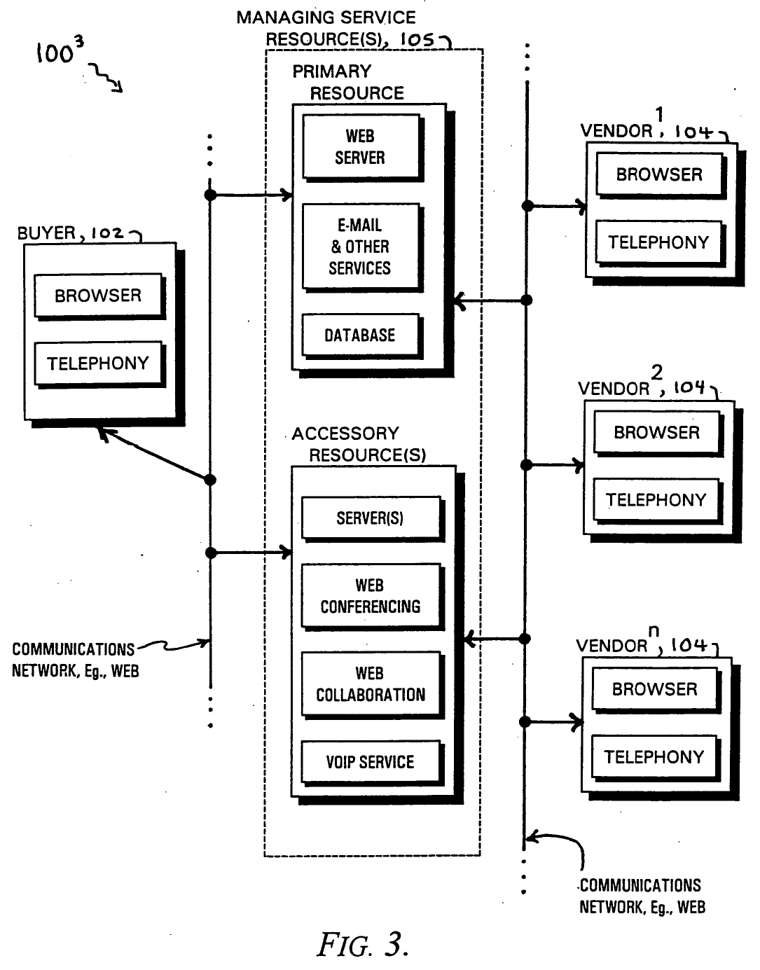

The drawings comprising FIGS. 1a-1c, 2a-2c and 3 classify into two (2) groups. This is done based on the “approach” taken to present the invention. FIGS. 2a, 2b and 2c comprise a group corresponding substantially the same to FIGS. 2a, 2b and 2c appearing in the priority U.S. patent application Ser. No. 09/511,431, filed Feb. 23, 2000, which is incorporated in its entirety by this reference to it as if fully set forth herein. FIGS. 1a through 1c and then FIG. 3 pertain more particularly to aspects of the invention involving the trustworthiness of the sealed-bid process when implemented on a communications network such as the Internet.

That aside, the description FIG. 2a, 2b and 2c will be taken up first. FIG. 2a, 2b and 2c comprise views of flowcharts showing an overview of an inventive system and method 100 for providing interactive bidding and purchasing services over a computer network. The system and method 100 is more particularly and distinctly disclosed in, as said, the priority U.S. patent application Ser. No. 09/511,431, filed Feb. 23, 2000, which is incorporated herein in its entirety by reference.

With reference to FIG. 2b, the method 100 facilitates the exchange of computer-implemented documents 138 among an alignment of three sets of parties 102, 104, 105. The buyer 102 comprises one party set. A set of vendors 104 comprises a second party set, wherein FIG. 2b shows the vendor parties enumerated as vendor¹, vendor², and so on, up to any indefinite number, the last in sequence being vendor ⁿ. The drawing does not require that there be at least three or more vendors. As discussed below, there are even uses for the inventive method 100 in as simple alignment as between a single buyer 102 and a single vendor 104. The third party set is a service party 105.

The server 105 may comprise a domain of server machines. The Information Systems specialists who administrate the server 105 are employed or contracted by a host organization. As an aside, the host organization may also provide organization services to the buyer and vendor clients 102 and 104 of the system and method 100 in accordance with the invention vis-a-vis memberships and the like. Indeed, the host organization might be collectively owned or controlled by the client users 102 and 104. Or at least the host organization might recognize proposals for amendments or updates to the system 100 from the buyer and vendor clients 102 and 104.

In FIG. 2b, the communication links between the boxes are transmission links sufficient to carry electrical, magnetic, radio, or optical signals of information. These communication links can comprise a heterogeneous mixture of telephonic or data channels, and by either wired or cabled or wireless paths and so on. In general, the method 100 takes advantage of the ubiquity of the Internet. Any of the foregoing client parties 102 or 104 which are not linked by private voice/data lines or private data networks or the like (and most often won't be) may link up by the Internet.

The server 105 will be attended to by information specialists, as customary. However, these persons will generally be restricted from reading the content of the transmissions between the buyer and vendor parties 102 and 104. The server 105 is established to carry out its functions in as viewpoint-neutral manner as practical. The philosophy behind this approach is that the server 105 should not influence the outcome of the process. Simply, the server 105 does not serve any party 102 or 104 as agent. Rather, it serves the integrity of the method 100 as a whole and therefore not only the parties as a community 102/104 but also their confidence in the trustworthiness in the method 100 as it is carried out by means of the computer-implemented forms 138.

FIG. 2a shows the general scheme underlying the transfer of computer-implemented documents 138 between a buyer 102 and vendor 104 as well as corresponding names for the documents 138. For sake of example, it is assumed that the origin of the first document might be a “Request for Bid” 140, of which the buyer 102 is the originator. It was mentioned above that the original document from the buyer is known in the field by a variety of names. For example, Request for Bid (sealed bid or otherwise), Request for Proposal, Request for Quote, Request for Price, Request for Information and so on. In the description that follows, the buyer's request is preferably referred to as a Request for Bid (abbreviated at times to R.F.B.). In generic terms, the paradigm of transactions comprises a request from the buyer, and response(s) from one or more vendors. The buyer then reviews the response(s) and decides if to bestow any award for the responses or the like.

Once the R.F.B. 140 is completed, the buyer 102 can transfer the formal R.F.B. 140 to the vendor(s) 104 via transmission over, say, the Internet. The vendor 104 receives a received version of the R.F.B. 140′, and opens it in the vendor's system 104′. The main program 100′ affords the vendor 104 a computer-implemented interactive session during which the vendor composes a response 144. The vendor 104 thus can transform the received form of R.F.B. 140′ into a form of Bid 144 during its study of and interactive session with the received R.F.B. 140′.

In due course the buyer 102 receives a received version of the response or bid 144′. The program 100′ is adapted to conveniently organize the multiple bid responses 144 in a spreadsheet. The spreadsheet utility spreadsheets the various responses/bids for quick comparison. FIG. 2b shows that the site of the spreadsheet utility is alternatively located on the server 105, as shown by activity box 152.

To return to the activity 153 of the buyer 102 studying the bid result 144′ (or tabulated bid results 144″ in FIG. 2b), whether one or many, the buyer 102 elects whether to accept any part of the bid 144′, and if so, then award a Purchase Order 146. That is, the buyer 102 reviews the item(s) bid 144′ given by the vendor(s) 104. For sake of example, assume the buyer 102 elects to award a Purchase Order 146 on some or all of the items bid by the vendor 104 in FIG. 2a. The buyer 104 executes a computer-implemented interactive session in which the data from the record fields in the bid 144′ are re-arranged into an computer-implemented form of Purchase Order 146. The buyer 102 then transmits the Purchase Order 104 to the vendor. And so on. On the vendor's machine, the computer-implemented form of Purchase Order 146′ can be automatically re-formed as a computer-implemented form of Invoice 148. Provided that the automatic Invoice 148 needs no personal intervention, it can be returned in the condition as-produced by the automatic format. As an aside, invoices are usually returned during some time frame associated with the delivery of the goods or performance of the services, as the business practices between the parties may dictate.

Also, in cases of simple (non-sealed) bids and sealed-bid competitions, the law or other applicable conventions may require that the bid results 144″ be published to the participants 104 if not a wider audience, whether or not there was a successful winner at least in part of a purchase order Award. To facilitate this, the method and program 100/100′ in accordance with the invention includes a command to allow the buyer 102 to broadcast the spreadsheet to whoever is afforded the privilege to or otherwise owed the results. In FIG. 2b, this broadcast activity is indicated as being carried out vis-a-vis activity box 155.

Turning now to FIG. 2b, it shows an expanded configuration of the flow of document(s) 138 for better illustrating a sealed-bid competition. In this configuration, there is a given buyer 102, the server 105, and a class of like vendors 104 denominated as vendor¹, vendor², and so on, through vendorⁿ. The origin for the inventive method 100 begins with the buyer 102. The buyer 102 writes a R.F.B. 140. This is accomplished by a computer-implemented interactive process. The R.F.B. 140 can be reckoned as having two components 141a and 141b. One component is the R.F.B. content 141a, which organizes in list-format what item(s) are proposed for bid responses. The other component is the address list 141b. Every addressee 104 gets materially the same R.F.B. message 141a except for that particular addressee's address. In the component 141a containing the R.F.B. content, there is a check box for designating whether the bid process is a sealed-bid competition or not. There is also an origin date field. And there is a due date and time field. These check box(es) and fields are better shown the drawings included with the above-referenced and incorporated priority U.S. patent application Ser. No. 09/511,431, filed Feb. 23, 2000. However, these check box(es) and fields are also shown diagrammatically by FIG. 2c.

Each vendor 140 receives a received version of the R.F.B. 140′. The method achieves sending back to the buyer a confirmation of receipt if indeed an R.F.B. is successfully received by any/every given vendor as shown as carried out by process box 154. The vendors 104 are put on notice of an appointed due or closing date and time. However, each participating vendor may complete its response 144 any time ahead of schedule, and sends back its response 144 when complete.

The handling of these returned bids in cases of sealed-bid mode competitions will be more particularly described further below in connection with FIGS. 1b and 1c.

It is an aspect of the invention that the majority of the forms used either for purchasing transactions or for bid competitions and the like are configured to allow data sharing or exchange. That way, a given party responding to a sent form can compose a responsive form which extracts as much of the redundant data in the sent form for automatic incorporation into the responsive form. Alternatively, another way of reckoning this is that the core data is left in place, it is merely the format of the imposed merge form which is substituted. This is sought to enable faster “turnaround” of the responsive form(s) while concurrently eliminating the chances of the responder inadvertently entering errors.

The implementation of the foregoing is shown in part by reference to FIG. 2c. The vendor 104 can open its received R.F.B. 140′ with comparably the same utilities and/or software package as used by the buyer 102 to originally create the document 140, except with several restrictions. Several of the data fields are “locked” in the sense that they are un-editable (note: the term “locked” is used in different senses in regards with sealed-bid responses as discussed further below). Thus, vendors 104 cannot edit data in such locked data fields. Hence even though a vendor 104 may be given substantially the same GUI screens as seen by the buyer 102, the vendor 104 is locked out of, for example, the description field 171. Vendors 104 cannot edit the description field 171 in a received version of an R.F.B. 140′.

In FIG. 2c, there are three columns. The left column represents a computer-implemented form of “Request for Bid” 140, the buyer's version. It is available for working in on the Buyer's machine 102′. The middle column represents a computer-implemented form of “Response” 144, as available on any given Vendor's machine 104′ but not a machine of the buyer 102. The right column represents a computer-implemented form of Bid 144′ and is available for viewing again back on the Buyer's machine 102′. The flow of forms 140, 144, 144′ is from left to right. The buyer 102 transmits the R.F.B. 140 to the vendors 104, who prepare their responses 144 and transmit back to the buyer 102 receivable versions of the responses 144′ or bids.

Each column contains the names of essentially the data fields which comprise the communications. The left margin of each column includes an indication whether that particular field is “unlocked” or “locked” (ie., accessible/editable or un-editable) to that user 102 or 104 at that instance. If the data field is unlocked, this is indicated by a check mark “✓.” If the data field is locked, then this is indicated by a strike mark “✓.” In cases where there is no indication, the method and system 100′ makes no attempt to control privilege to the access in that field at that instance.

FIG. 2c shows the following. Certain fields are the responsibility of the buyer to complete when preparing the R.F.B. 140. Certain other fields are provided to enable the vendor 104 to complete a material response 144 to the R.F.B. In the vendor's machine 104′, the vendor 104 is generally locked out of the fields deemed to be the responsibility of the buyer 102.

The inclusion of one field to lock while excluding others from locking is in some senses a designer's choice from the perspective of the designer of a given implementation of the method and program 100/100′ in accordance with the invention. Consider the description field 171. It is in this field 171 that the buyer 102 describes the item(s) up for bid. That vendor 104 is locked out from the description field 171, not so much as to protect the buyer 102 from getting back a deceptively changed description but, as much for the protection of the vendor 104 as assurance that the vendor 104 can't errantly change the description then deprive itself of knowing what, precisely, was the original description.

As another example, consider the attachments field or applet 189′. Each party gets to attach attachments. In the FIG. 2c configuration of a locking scheme, no attempt is made to lock out the vendor 104 from the attachments field 189′. Simply because, business ethics and/or legal rules do not authorize the vendor 104 to change or amend the buyer 102's attachments unless the buyer 102 authorizes the vendor 104 to do so. The vendor 104 can of course supplement the attachments field 189′ with its own, or it may be authorized to work on the buyer 102's attachments. Perhaps other fields which FIG. 2c show as locked to the vendor 104 could be unlocked because of the practical harmlessness in leaving the fields unlocked. Nevertheless, it is an object of the invention to preserve the original content of the R.F.B. 140 for its faithful later publication at the close of the sealed-bid competition.

FIG. 2b shows the buyer's study activity indicated by block 153. If the buyer 102 decides to award winners in part or a winner in total (eg., not split items among plural vendors), the buyer 102 is afforded an interactive P.O. Award session 224. The program 100′ provides the buyer with removing the locking of the un-editable fields. That way, whereas the buyer 102 is “locked” out from editing or amending the spreadsheet results 144″, the buyer 102 is ultimately empowered to unlock the spreadsheet 144″ but only for extracting data for the major purpose of creating a computer-implemented form of purchase order 146 or message 138a. In other words, the buyer 102 can import or re-compose the data entry(ies) from the winning bid(s) into a computer-implemented form of Purchase Order 146. The buyer 102 transmits the form of P.O. 146 to the winning vendor 150. The buyer 102 can contemporaneously instruct the server 105 to release the tabulated results to the participating vendors, which is carried out as indicated by process box 155 (see FIG. 2b). Staying in FIG. 2b, it shows that vendorⁿ is the winning vendor 104. Each of vendor¹, vendor², and so on, through vendorⁿ, are also transmitted a copy of the spreadsheet results 144″. The spreadsheet results 144″ come directly from the server 105 as a means of assuring the integrity of the data. As previously mentioned, this activity serves the integrity of the process 100 as a whole so that all participants can feel confident in an impartially hosted sealed-bid competition as transacted by computer-implemented forms sent over, say, the Internet. Additionally, the winning vendorⁿ is empowered to re-configure the received computer-implemented form of Purchase Order 146′ into its own a computer-implemented form of Invoice 148. The foregoing comprises a discussion of various aspects of the inventive method and system 100.

To revisit the “read aloud” event, the service bureau 105 and network 100 in accordance with the invention provides live, preferably on-line broadcasts of these events so that interested vendors 104 no longer have to go in person to witness the bid openings or “unsealings.” The buyer 102 will hold the “read aloud” event in front of digital cameras or the like and pipe this material over the Internet to the service bureau 105's applicable software support module. In turn, the service bureau 105 will provide this material real-time live on audio and/or audio-visual bases for whichever vendors 104 desire to tune in. More will be said about that further below in connection with FIG. 3.

Pause might be taken before moving on to examining FIGS. 1a through 1c. Applicant contracted with ORACLE® Corporation of Redwoods, Calif., to implement and host the method and system in accordance with the invention on behalf of applicant. To accomplish this, applicant issued ORACLE® a “Work Order” request, describing the functionality that applicant preferred. ORACLE® came back with a “Method of Implementation” response. Both these documents merit inclusion here, and are given next as “Example A” and Example B,” respectively.

### EXAMPLE A.

Work order request, entitled: Sealed Bid Requirements [].

Overview. The Sealed Bid Process is required by public agencies (ie., city, state, federal governments) on any procurement activities above a pre-defined threshold. Statutes require the Sealed Bid Process in order to insure that both vendors and the buyer have no knowledge of the submitted bid results of any vendor prior to the bid opening date and time. Standard practice consists of several procedures to prove that the bid results are kept secret:-

1. Bid responses are sealed in an industry-accepted manner (ie: sealed envelope) and returned to the buyer.

2. As the buyer receives bid responses they are typically placed in a physical lock box or secured location.

3. A public bid opening is held giving everyone equal access to view the bid results as they are unsealed thus verifying that the bids were unopened and that the statutes were met.

Definitions. “Public Bid Process” describes mandatory procurement statutes imposed on government agencies to insure a fair open market. “Request for Sealed Bid” describes a public buyer-created document to solicit competitive pricing. “Sealed Bid” can be taken as describing a vendor's response to a Request for Sealed Bid that includes the vendor's best offer for the requested products or services. Such Sealed Bid document(s) is(are) typically sealed and so not viewable by anyone until the stated dated and time. “Lock Box” describes a secured location that Sealed Bids are kept until the bid opening. “Bid Opening” for one of its meanings describes a public event satisfying applicable Sunshine laws where the Sealed Bids are opened and made available to view by any interested parties.

User Procedures. 1. Create Request for Sealed Bid. Buyer specifies the Terms and Conditions, items/services to be purchased, and that the bid responses are to be sealed and the date and time of the public bid opening. This can be indicated via a radio button or check box. The buyer should be able to either create the document manually or populate the document via an uploaded spreadsheet or via direct integration with their back-end system.

2. Issue the Bid. Buyer issues the Request for Sealed Bid to selected vendors.

3. Respond to the Bid. Vendors receive, review and compose their offer, and then return their bid. Because the Request for Bid was marked as Sealed, the response contents need to be hidden from all users until the date and time of the bid opening specified by the buyer. A buyer should be able to view that he has received the response, who it is from, and the time/date it was received. There also needs to be an indication that the document is “locked” and cannot be opened (ie., a red closed padlock icon). Vendor should also be able to see the time and date the document was submitted to the system and an indication that it is “locked.”

4. Bid Opening. After the specified date/time for the bid opening, the locked indicator (for both the buyer and vendor) needs to change to reflect that the document is now available to open, but is still “sealed” (ie., a green closed padlock icon). This allows the buyer to demonstrate that the document has not been opened. When the buyer is ready to “unseal” the responses, he clicks on a button titled “unseal documents” which then makes the documents viewable. The locked indicator should then change to reflect that the documents have been unsealed (ie., a green opened padlock icon). Also, the date/time of the unseal event should be logged as an auditable event and shown next to unsealed documents. Additionally, a live clock showing the server date and time (based on the time zone of the user) should be displayed to both the buyer and vendors.

5. Reporting. The views as stated above should satisfy any reporting requirements. To recap, the buyer needs to be able to view/print a list of who responded, the date/time each bid was received, and the date/time the bids were unsealed.

### EXAMPLE B.

Work order response, entitled: Method of Implementation.

[Note about terminology: “Blind Auction” vs. “Sealed Bid.” In this response, “Blind Auction” is used in preference over “Sealed Bid.” Hence “Auction” or “Reverse Auction” as used in this response generally corresponds to Sealed Bid or Request For Quote, or else Request For Sealed Bid, Request For Proposal, Invitation For Bid, etc. Despite use of “Auction,” the sealed bid process/functionality is the same.]

Overview. Blind auctions allow auctioneers to host an auction, receive bids for that auction, and guarantee that none of the bids will be viewed by the auctioneer until a pre-specified date and time. This procedure assures bidders that the bid evaluation process is fair to all participants.

In government agencies, bidders must have the ability to submit bids that won't be viewed until a pre-specified date and time, multiple rounds of bidding are generally not allowed, and bidders may be required to bid exactly what the auction requests. Blind auctions can support these requirements which may streamline and expedite the bidding and award processes.

While blind auction is a requirement specific to the public sector, any auctioneer can utilize the functionality. Without blind auctions, government groups cannot participate in the Exchange. The real estate industry may also benefit from blind auctions. Note: negotiations are more likely to ensue in a real estate deal. Ultimately, bidders participating in blind auctions are forced to bid their best bid price.

Definitions. “Open Bid Date and Time (or Unlock Bid Date and Time)” describes the date and time when bids submitted in a blind auction can be unlocked and subsequently opened. “Locked Bids” describes bids received and stored prior to the Open Bid date and time. Both the auctioneer and the bidders cannot view the bid content of a locked bid. Locked bids cannot be opened.

“Unlocked Bids” describes the following, ie., once the Open Bid date and time is reached, all bids received for a blind auction can be unlocked. Once a bid is unlocked, the auctioneer can view the bid content, but bidders cannot view bid content. Unlocked bids can be opened. “Open Bids” indicates that, once the bids in a blind auction have been unlocked, the auctioneer can open these bids. At this point, both the auctioneer and the bidders can view the bid content.

Business Needs. • Bidder needs the ability to submit a bid that the auctioneer cannot view until a pre-specified date and time. • Auctioneer needs the ability to receive bids and guarantee that auctioneer will not view the bids before a pre-specified date and time.

Business Rules. When an auctioneer creates an auction, the auctioneer can select a bid control to communicate to the bidders that this auction is a blind auction. A blind auction keeps all bid content information confidential until a pre-specified date and time. At the pre-specified date and time, the auctioneer can view the bids submitted for the first time by unlocking the bids. The auctioneer can then “open” the bids to make the bid content available to the bidders. The date and time the bids were unlocked and opened can be viewed by the bidders.

It is noted that, blind auctions apply to buyer's auctions only.

In creating an auction, once an auctioneer submits an auction, the auction cannot be edited. Anytime prior to publishing the auction, the auctioneer can select or deselect the Blind Auction bid control. When the auctioneer creates a blind auction the bidding is sealed for both the auctioneer and the bidders.

A “preview date and time” utility is not required, but may be utilized by some auctioneers.

There is a parameter of “Open Bid Date and Time (or Unlock Bid Date and Time)” to factor. Once the auctioneer opts to have a blind auction, the auctioneer must also enter an Open Bid date and time. The Open Bid date and time must be later than the auction close date and time. Prior to the Open Bid date and time, the auctioneer can view who submitted bids when, but not the bid content.

The matter of allowing or not re-bidding is left to the discretion of the auctioneer. The purpose of re-bidding would be to allow the bidder to correct a mistake it made when submitting its bid.

The matter of locking and/or unlock bids involves the following. All bids received in a blind auction are automatically locked. At the time of the Open Bid date and time, the auctioneer can unlock the bids. This preferably applies to all bids at once, not individually. Once the bids are unlocked the auctioneer has access to the bid content. Likewise, this preferably applies to all bids at once, not individually. Locked bids cannot be opened.

The matter of “Open” vs. “Sealed Bidding” involves the following. Blind auctions preclude bidders and the auctioneer from viewing bid content prior to the Open Bid date and time. Prior to the Bid Open date and time, auctioneers can view who submitted bids, and perhaps when, but not the bid content itself. Once the bids have been unlocked, the auctioneer may want bidders to be able to view the bids, including the bid content submitted. To do this, the auctioneer can open the bids. Open bids can be viewed by both the auctioneer and the bidders.

A “Cancel” auction utility is provided which, once an auction is canceled, no additional bids will be accepted. Bids already submitted are null and void.

Otherwise, it can be expected that there will be an auction award. Once an auction is closed, the auction is displayed in Award Auctions. For blind auctions, auctioneers should not be able to view the bid content prior to the Open Bid date and time. After the Open Bid date and time, the auctioneer unlocks the bids. Once the bids are unlocked, the auctioneer can view the bid content and begin the award auction process.

User Procedures. 1. Create Auction. An auctioneer selects the blind auction option in the bid control process. Under the section “Who can see the bids?,” add blind auction. All exchange members can see the bids, although bidder identity is concealed. Only the auctioneer can see the bids. Neither the bidders nor the auctioneer can see the sealed bids during the bidding process.

When the auctioneer selects “Neither the bidders nor the auctioneer can see the bids,” the page should refresh requesting a Bid Open date and time. Alternatively, this field can be visible prior to selecting the blind auction option, but the page can validate that it is filled in prior to navigating off the page.

2. Enter Open Bid Date and Time (or Unlock Bid Date and Time). If blind auction is selected the Open Bid date and time must be entered. The auctioneer cannot navigate off the Bid Control page without setting an Open Bid date and time. Open Bid date and time should be displayed on the Bid Control page, as in the new date and time field, as well as on the Review and Submit Auction page.

3. Place Bid. In a blind auction, the bidder submits a bid. Once the bid has been submitted, the bidder can only view the bid it submitted. The bid export is also impacted, as auctioneer should not be able to export bids until after the status is “unlocked.”

4. Auction-Bids Status. Since this is a sealed bidding auction, the auction-bid status is displayed as Sealed. The Bid status can be broken down to a more granular level to account for all phases of blind auctions.

Locked: neither the auctioneer, nor the bidders can view bid content.

Unlocked: the auctioneer can view bid content, but bidders cannot.

Unsealed: both the auctioneer and bidders can view bid content.

5. Current Best Bid. Since this is a sealed bidding auction, the current best bid is displayed as Sealed. The monitor bid status page should not be accessible until after status “unlocked.”

6. Lock/Unlock and Sealed/Open Bids. Both the bidder and the auctioneer should be able to easily view bid status. The bidder can view bid status from the View Auction page or through View Bid History. The auctioneer can view bid status before the auction close date and time from the View Auction page or View Bid History page. Once the auction is closed, the auctioneer should be able to easily identify which auctions are blind and which are not from the Award Auction page. Likewise, the auctioneer should be able to view the status of the bids in a blind auction: locked, unlocked, or opened.

For blind auctions, the auctioneer needs two action buttons. Unlock Bids and Open Bids. Once the Bid Open date and time arrives, the auctioneer must unlock all the bids received. This action simultaneously unlocks all bids received and can take place anytime after the Bid Open date and time. When the bids are unlocked, the date and time needs to be recorded. The unlocked date and time needs to be accessible to the bidders and the auctioneer.

Once the bids have been unlocked, the auctioneer can open all the bids received. This action simultaneously opens all bids received and can take place anytime after the unlock bids date and time. When the bids are opened, the date and time needs to be recorded. The opened date and time needs to be accessible to the bidders and the auctioneer.

7. View Auction Inquiries. Include blind auction in Bid rules/controls and the Open Bid date and time.

8. View Auction/Bid History Inquiries. If the auctioneer wants to view the bid history of a blind auction prior to the Open Bid date and time, the auctioneer should get a message that states, “This is a sealed auction. You are unable to view bid content until the bids have been unlocked and unsealed. The Open Bid date and time for this auction is <Open bid date/time>.”

Once the bids have been unlocked, the bidders and auctioneer should be able to view the date and time they were unlocked. Once the bids have been opened, the bidders and auctioneer should be able to view the date and time they were opened. The auctioneer can view the bid history of a blind auction after the bids have been unlocked.

If the bidders want to view the bid history of a blind auction, the bidders should only be able to:

View their own bid and no one else's, and optionally get a message that states: “This is a sealed auction. You are not allowed to view bids other than your own.” The bidder should be able to view its own bid anytime.

View the winning bid.

If the auctioneer opened the bids to all bidders, the bidders should be able to access the bids through the bid history.

Conclusion: Issues. Open Issue number 1. What should this functionality be called? Response: though the public sector refers to this as sealed bidding, once customization is available to the end user, they can call it whatever they want. Open Issue number 2. Are the bids still sealed once they are opened or can other bidders view each other's bids? Response: the disclosure process is twofold. The first step is to unlock the bids. When the bids are unlocked the auctioneer can view the bid content. The second step is to open the bids. Opening the bids would allow bidders to view the bid content of all bid received, unlocked, and opened in the auction.

Appendix.

United States Government Regulations on Sealed Bidding.

[All section citations to the Federal Acquisition Regulations (FAR), which is a development jointly of the Department of Defense, the Administrator of General Services, and the National Aeronautics and Space Administration.] From: http://www.arnet.gov/far/loadmain.html

§14.101. Elements of sealed bidding.

Sealed bidding is a method of contracting that employs competitive bids, public opening of bids, and awards. The following steps are involved:

(a) Preparation of invitations for bids. Invitations must describe the requirements of the Government clearly, accurately, and completely. Unnecessarily restrictive specifications or requirements that might unduly limit the number of bidders are prohibited. The invitation includes all documents (whether attached or incorporated by reference) furnished prospective bidders for the purpose of bidding.

(b) Publicizing the invitation for bids. Invitations must be publicized through distribution to prospective bidders, posting in public places, and such other means as may be appropriate. Publicizing must occur a sufficient time before public opening of bids to enable prospective bidders to prepare and submit bids.

(c) Submission of bids. Bidders must submit sealed bids to be opened at the time and place stated in the solicitation for the public opening of bids.

(d) Evaluation of bids. Bids shall be evaluated without discussions.

(e) Contract award. After bids are publicly opened, an award will be made with reasonable promptness to that responsible bidder whose bid, conforming to the invitation for bids, will be most advantageous to the Government, considering only price and the price-related factors included in the invitation.

§14.103. Policy.

14.103-1. General.

(a) Sealed bidding shall be used whenever the conditions in 6.401(a) are met. This requirement applies to any proposed contract action under Part 6.

(b) Current lists of bidders shall be maintained in accordance with 14.205.

(c) Sealed bidding may be used for classified acquisitions (see 4.401) if its use does not violate agency security requirements.

(d) The policy for pricing modifications of sealed bid contract appears in 15.403-4(a)(1)(iii).

14.103-2. Limitations.

No awards shall be made as a result of sealed bidding unless--

(a) Bids have been solicited as required by Subpart 14.2;

(b) Bids have been submitted as required by Subpart 14.3;

(c) The requirements of 1.602-1(b) and Part 6 have been met; and

(d) An award is made to the responsible bidder (see 9.1) whose bid is responsive to the terms of the invitation for bids and is most advantageous to the Government, considering only price and the price related factors included in the invitation, as provided in Subpart 14.4.

§14.104. Types of contracts.

Firm-fixed-price contracts shall be used when the method of contracting is sealed bidding, except that fixed-price contracts with economic price adjustment clauses may be used if authorized in accordance with 16.203 when some flexibility is necessary and feasible. Such clauses must afford all bidders an equal opportunity to bid.

To turn now to the matters of FIGS. 1a-1c, starting originally with FIGURE la, it shows a simplified schematic diagram showing the various participants to a virtual sealed-bid competition 100 in accordance with the invention, shown interconnected with one another by a communications network. One or more vendors 104 are interlinked with a given buyer 102 and the service association 105 by the communications network, which in a preferred embodiment of the invention is the Internet.

FIG. 1b is a TABLE tabulating various example ways BID responses 144 (see eg., FIG. 2b) produced by vendor(s) 104 can be routed to the buyer 102 over the communications network, including some cases (not all) in which the routing of the bid responses 144 is mediated in any proximate way by the service 105. The TABLE comprises three (3) columns labeled I-III. Column I. denotes the location from where the vendor 104 likely sends or releases its bid response 144. Column II. covers how (if applicable) transit of the bid response 144 is mediated by the service 105. Column III. denotes the location from where buyer 102 gains first access to the bid 144. The columns cover nine (9) example cases illustrative of various ways the bid responses 144 might be routed.

Case 1. deals with when the vendor 104 transfers the bid 144 directly to the buyer 102 without routing through the service's server 105. An example of this is e-mail (or web-mail or other modes) served by other servers and routers, with no hop through an service's server/site 105.

Case 2. shows the situation when the vendor 104 transfers the bid 144 to the buyer 102 and the bid 144 makes a simple hop through the service's site/server 105. An example of this might be an e-mail transiting through service's server/site 105, where the service 105 does not specially monitor and treat the bid response 105 except make a record in a preserved log of the bid communication's arrival to and departure through the server 105.

Case 3. illustrates the situation when the vendor 104 transfers the bid 144 to the buyer 102 and the bid 144 makes a modified hop through the service's site/server 105. An example of this might be an e-mail transiting through service's server/site 105. In the process, the bid communication might be encrypted such that the buyer needs a decryption key to read the bid. Alternatively, the bid communication might be compressed or coded as well as bundled with a script or tag that executes on the buyers machine upon the decompression or decoding of the of the bid communication. The script or tag might set an encrypted value in a cookie for retrieval by the service 105 at a later date. The script or tag might otherwise encrypt a message on the buyer's machine which again can be retrieved by the service 105 at a later date. Generally, the encrypted value or message will record the time when the buyer originally decompressed or decoded the bid response message. At such a later date as when the service 105 retrieves the encrypted value or message, it can determine the buyer's faithfulness in not “unsealing” the bid response 144 before the deadline.

Case 4. represents the situation when the vendor 104 transfers the bid 144 to the buyer 102 through the service's site/server 105 and the service 105 imposes a condition on the release of the bid 105 to the buyer. The condition might be, for example, that the buyer 102 is denied access until after the appointed deadline.

Case 5. shows where a buyer posts its “request for bid” 142 on its own server, independent of the service's server 105. Vendors 104 browse the buyer 102's server for such “request for bid” notices 142, and compose and leave there responsive bids 144′. Like case 1., the service's server/site are not involved at least to that stage.

Case 6. deals with when the service provides, for example, a web site or page for serving the “request for bid” notices from there for the vendor 104 to browse on the vendor's browser. The request data 142 can be reckoned as resident on the server's site 105. When the vendor 104 composes a responsive bid 144, the bid response 144 remains resident on the server's site 105. However, the buyer 102 connects to the service 105 and calls for the bid responses 144 to be downloaded onto the buyer's machine and away from the service's ability to record and log the buyer's activities with the bid responses 144′ after the connection is broken.

Case 7. is like case 6. in ways. That is, case 7. is like case 6. in that the service 105 provides, for example, a web site or page for serving the “request for bid” notices 142 from there for the vendor to browse with that vendor's browser. The request data 142 can be reckoned as resident on the server's site 105. When the vendor 104 composes a responsive bid 144, the bid response 144 remains resident on the server's site 105. Unlike case 6., this time in case 7., the buyer 102 also browses the bid responses 144 with the buyer's own browser. That way, the buyer's activities with the bid responses 144 can be recorded in a log. The bid responses 144 can be reckoned as remaining resident on the service's server/site 105.

Case 8. is included among cases 6, 7 and 9 for reference back to cases 2 through 4. That is, e-mail aside, Internet communications can route through the service's server in accordance with any other protocols, including web-mail or Internet chat or other file and/or data transfer protocols. Regardless of the protocol, the service might mediate the routing of the transiting bid response 144 in accordance with simple, modified and conditional exchanges described previously in connection with cases 2, 3 and 4, respectively.

Case 9. is a variation of case 7. Unlike case 7., case 9. has the vendor uploading its responsive bid 144 onto the server's site 105. More like case 7. however, case 9. holds the responsive bid 144 on its site for the buyer 102 to access by browsing. That way, the buyer's activities with the bid responses 144 can likewise be recorded in a log. The bid responses 144 can be reckoned as remaining resident on the service's server/site 105 and not truly downloaded onto the buyer's machine or site.

Given the foregoing, FIG. 1c is a compilation of alternate integrity assuring methods in accordance with the invention for virtual sealed bid competitions held over a computer communications network such as the Internet. “Virtual” sealed bid means, as used in this description for mere sake of convenience, an e-commerce analog to what to date (or til the recent past) has been transacted with actual sealed envelopes. In the instances of the responsive bid communications 144, these cannot be truly sealed as envelopes can. Nevertheless, the integrity of a virtual sealed-bid competition in accordance with the invention 100 is reliant on part on whether a buyer 102 faithfully does not open, access or otherwise “unseal” the bid responses 144 until after the appointed deadline. Nowadays, given the new environment of electronic commerce, FIG. 1c shows six alternate methods (enumerated nos. I through VI) which address this integrity assurance issue.

Method no. I. allows the vendors 104 to transfer their bid responses 144 to the service 105 before deadline, for storage there at the service 105. The service 105 then simply denies buyer 102 access to the bid responses 144 until after deadline. This method no. I. accommodates case nos., among others in FIG. 1b, case nos. 4, 6 7 and 9. As regards case nos. 6 and 7, the vendor 104 does not so much as transfer its bid response 144 to the service 105 as leave its bid response 144 there. Regardless, the salient feature of method no. I. is that the buyer is denied access.

Method no. II. allows the vendors 104 to transfer their bid responses to buyer before deadline, but the bid responses 144 are encrypted by a given public encryption key. The buyer 105 must contact the service 105 for the decryption key but the service 105 denies the buyer 105 access to the decryption key until after deadline. This method no. II. accommodates case nos. 1 and 2 in FIG. 1b, as well as no doubt several more of the others.

Method no. III. permits the vendors 104 to transfer (or leave) their bid responses 144 to (or with) the service 105 before deadline. The buyer 102 obligates itself to not call for the bid responses until after the deadline. The service merely records a log of the buyer's activity(ies) with the bid responses 144. The buyer must beware, that if it calls for the bid responses 144 before the deadline, the service 105 cannot refute anyone's allegations that the buyer abused its obligations with respect to leaving the bid responses unmolested until after the deadline. This method no. III. accommodates at least case nos. 4, 6, 7 and 9 in FIG. 1b. In the instance of case no. 4, the “condition” of the conditional relay is a specific call from the buyer to download or open the “sealed” bid responses 144. That is, the server 105 ordinarily holds “sealed” response bids 144 back until the buyer takes some affirmative action to download the bid responses 144 other than contacting the service 105 calling for its ordinary e-mail, web-mail, web-pages and/or chat messages also found on the service 105's site.

Method no. IV. has the vendors transferring the bid responses 144 to buyer before deadline, but the bid responses 144 are formatted in compression or code. As an original matter, the service 105 provides all the users 102 and 104 with aspects of the compression or code software. The noteworthy aspect is that, while the buyer 102 also has the software to decompress or decode the bid responses 144, such activity as that activity sets a value for a cookie or, eg., encrypts a message. The service 105 retrieves the value(s) or encrypted message(s) at some subsequent connection with the buyer. The service 105 can analyze the value(s) or encrypted message(s) and conditionally certify the buyer's faithfulness in not opening the bid responses 144. To make this work, the process of opening a given bid response 144 successive times cannot overwrite the earlier set value or message. Also, since the value or message is likely preserving the time and date that the buyer 102 opened the bid response 144, the buyer might subvert this message by changing its machine's clock. Another way the buyer 102 might subvert this method is copy the compressed or coded bids 144 to a second machine and open them there. That way, the “smoking gun” evidence can be hidden and perhaps destroyed out of sight

A variation of method no. IV. can be reckoned from case no. 3 in FIG. 1b. As a bid response 144 is being released from the service 105 to the buyer 102, the service might tag the communication 144 or include a script with the communication such that when the buyer executes such a command as ‘decompress’ or ‘decode,’ the tag or script executes. The tag or script can encrypt a message with a public key that includes the time and date the bid response 144 was opened. The service 105 can afterwards retrieve the encrypted message and decrypt it to provide some evidence of the buyer's faithfulness or not of waiting until after the deadline to open the bid 144. The buyer must beware, that if the encrypted messages are molested or deleted, then the service 105 cannot refute anyone's allegations that the buyer abused its obligations with respect to leaving the bid responses 144 unmolested until after the deadline. Also, this method might, like said above, be subverted by the buyer copying the messages to a second machine and wrongfully opening them early there.

Method no. V. has the vendors 104 transferring their bid responses 144 to buyer 102 before deadline, and again the bid responses 144 are preferably formatted in compression or code. Again the buyer 102 has software to decompress or decode the bid response 144, and again that activity sets a value in a cookie or, eg., encrypts a message. The buyer 102 obligates itself to check-in with the service 105 at least one last instance before opening or “unsealing” the bid responses 144, and presumptively this is preferably after the deadline too. This one last check-in by the buyer allows the service to retrieve the cookie with the value or upload the encrypted message and in order to conditionally certify the buyer's faithfulness. Like mentioned previously, this method too can be subverted by the buyer copying the compressed and coded messages to a second machine and wrongfully opening them early there. That way, the smoking gun evidence will not be found on the buyer's clean machine held out for the service's inspection.

Method no. VI. has the vendors 104 transferring their bid responses 144 to buyer 102 before deadline, and again the bid responses 144 are formatted in compression or code. In this instance, the buyer is deprived of the software needed to decompress or decode the bid responses 144. The buyer can only do so during an on-line session(s) with service. By this method, the service 105 can either (i) deny the buyer a session until after the deadline or (ii) log the buyer's activity.

As mentioned much earlier, this written description would revisit the matter of the “read aloud” event. As said at that previous instance, the service bureau 105 and network 1003 (eg., see FIG. 3) in accordance with the invention provides live, preferably on-line broadcasts of these events so that interested vendors 104 no longer have to go in person to witness the bid openings or “unsealings.” The buyer 102 may hold the “read aloud” event in front of digital cameras or the like and pipe this material over the Internet to the service bureau 105's applicable software support module. In turn, the service bureau 105 will provide this material real-time live on audio and/or audio-visual bases for whichever vendors 104 desire to tune in.

Now turning more particularly to FIG. 3, it shows how a given procurement event 1003 in accordance with the invention—such as an unsealing event or a complete, emulated sealed-bid competition—can be transacted by means of a web-meeting process.

By way of background, web meetings (eg., web-conferencing and/or -collaborations) give the participating parties the ability to conduct meetings as by talking among one another, and make presentations (as seen on each one's own screen) just as if they were their sitting in the same room. More significantly, web meetings further enable each other to share software applications and hold interactive chat or other computer-implemented tools such as serving/browsing: which is unlike sitting in the same room.

It is expected that through natural progression, Internet users who to date who work with voicemail and e-mail in their office, will likely expand their business tool-kit to include web conferencing and collaboration, and thereafter conduct combined voice, data and video conferences.

Conventionally, web conferencing is defined in accordance with two general ways to do ‘meetings on the Web.’ “Conferencing” proper allows a presenter to invite attendees to watch and participate in the meeting and presentation. All sorts of additional services are possible too, such as, the presenter can admit remote guest speakers. “Collaboration” allows a user to share with other users a document or a specific software application across the stretch of space, each user being miles apart, and work on it together. The work of one user appears simultaneously on the computer screens of the other users in the audience.

Many of the things a presenter or host can do in a meeting or presentation, whether it involves many people or just a few, can be comparably done in a web meeting. The following are examples. That is, for one-to-one meetings, each user can work on the same document or project together without leaving each other's office, no matter how far apart, whether across town or twelve time zones. With few-to-few meetings, a main presenter can present ideas to a group, or introduce the group to a panel of remote experts to solve a problem. Whatever the reason for getting people together, they can be pulled together all on the same web page through a web meeting. In few-to-many meetings, this allows the broadcast simultaneously to an audience of hundreds—whether a buyer's vendors or employees—in real-time, around the globe. To accomplish this, a buyer may decide to hold a given procurement event by a web meeting. The buyer posts the schedule for it, and provides a “room number” at the given web-conferencing resource (eg., Internet address). Hundreds of attendees can show up (eg., join in). The buyer can present its “request for Bid” communication in web-page format vis-a-vis a PowerPoint® presentation or the like, and then supervise the running of the procurement event. At the end of the PowerPoint® presentation of the “request for Bid” matter(s), the buyer can open up the meeting for submission of responses from the audience. The time for responses might be set clock-out at a given deadline. If the deadline is less than a few hours, the buyer might keep the web-meeting open and hold the entire session live from start to finish. If the matters presented for responsive bidding are more involved, the deadline might be set for another day. The buyer might close the original web meeting during which the “request for Bid” matters were originally published, and then unseal the bids at a later date after the deadline. The unsealing event might be hosted by the buyer during a succeeding web-meeting session. Each vendor in the audience preferably is limited to one-round of response, and in accordance with the generally accepted sealed-bid rules.. The substantive content of the responses are kept hidden from all other vendors, as well as (significantly) the buyer. At the conclusion of the deadline, the parties are in position for the buyer to unseal the bid “responses” and make an award finding (if any).

An example of an application-service-provider (ASP) for web-meeting utilities includes without limitation the service of the Astound corporation, Chicago, Ill., at www.astound.com.

Web meeting services in general offer an integrated, business tool-kit for real-time multimedia web conferencing and collaboration, just-in-time information delivery, at a self-paced, on-demand rate of viewing or collaboration, which includes training. Hence such web meeting capabilities span conferencing, collaboration, information delivery and training. Web meetings advantageously facilitate the delivery of rapidly changing business-critical information and real-time vendor collaboration, as well as just-in-time training to the desktop of any member of the audience. As said, web meetings in many way allows participants to meet just like ‘being there.’ Web conferencing and collaboration may eventually become as pervasive as e-mail.

The voice service of a web meeting can be handled by using VOIP (voice over IP), which offers to eliminate the considerable costs of conference calls, especially in cases of a wide audience that spans the globe. Several presenters can participate simultaneously, just as in a face-to-face meeting. A presenter can easily sequence through slides or segments of animation—or tour the Web—in real time for its audience. In addition, the presenter insert ad hoc polls into presentations. That is, a buyer can open the web meeting up for responses at intervals during the meeting. Other web-meeting capabilities allow a presenter to gather information about the audience, such as who is signed in.

To deliver the live speech that accompanies a presentation, the presenter's audio is encoded (for example as from a phone call) in real time and then delivered over the IP connection using say, RealPlayer® or Windows® Media Player. Generally both audio and video streams would be automatically synchronized with other presentation content and archived for on-demand playback.

As FIG. 3 shows, a buyer 102 is provided with the following options for holding a procurement event by means of a web meeting.

The buyer 102 can host the “unsealing” event by means of a web meeting. The audience 104 gets perhaps a multi-media presentation, providing screen displays of the unsealed “response” communications as the buyer 102 unseals them in series. Additionally, perhaps the audience 104 gets the buyer 102's “reading-aloud” audio feed as the buyer 102 recites the contents of the unsealed “response” communications. Otherwise, the audience 104 may not need any actual audio signal and just watch the event on screen. The screen displays can comprise any combination of individual “response” communications, a spreadsheet of the results in progress or as a whole, live camera views of the purchasing agent and environs, and so on. There is no real limit.

Alternatively, the buyer 102 can host a “request for bid” event by means of a web meeting. In this instance, the buyer 102 can present by means as progressive as a polished PowerPoint® presentation, what the matters are that the buyer 102 is listing for bid. The buyer 102 can then inform the buyer 102's audience 104 of the deadline. The buyer 102 can keep the web meeting open until the passage of the deadline, so that the complete sealed-bid competition is hosted online live. Or else the buyer 102 might close the session, and re-open it for an unsealing event as previously described. Additionally, the buyer 102 might do each item in a quick turn-around style such as follows. Say, a given item might be described, bid responses will be taken for the next twenty (20) minutes or so, then here's the next small item for bid, with responses on it to be taken until an hour later, and so on. The time given for getting a bid response in should correspond to the experience of the audience 104 and the value of the item for bid.

The web-meeting process affords the buyer 102 multiple features to hold procurement events. The audience 104 need not be specifically limited to vendors only, and can be broadened in scope accordingly. The given procurement event held by such a web-meeting process can be archived for later access by authorized parties at will. The spreadsheets results thereof, or whatever report concludes the event, can also be downloaded by users 102 and/or 104 for preservation for their own records as they see best.

Accordingly, the invention having been disclosed in connection with the foregoing variations and examples, additional variations will now be apparent to persons skilled in the art. Parts of the description uses terms for a computer system such as screens, windows, boxes, buttons, mouses, databases, records, fields and the like, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through mechanical and electrical components of the computer system. The term “system” (ie., computer ^{˜}) includes general purpose as well as special purpose data processing machines and the like, that are standalone, adjunct or embedded. The term “mouse” as used herein encompasses any manner of cursor-interactive device including keypads, graphic tablets, x-y pads, joy sticks and so on. The invention is not intended to be limited to the variations specifically mentioned, and accordingly reference should be made to the appended claims rather than the foregoing discussion of preferred examples, to assess the scope of the invention in which exclusive rights are claimed.

1-21. (canceled)

22. A method of transacting a sealed bid competition over the Internet, comprising the steps of:
providing a requester that is intending to hold a sealed bid competition with computer-implemented means for originating a “request for bid” communication that includes bid data as well as a parameter of deadline;
providing a plurality of vendors with access to the “request for bid” communication by means of the Internet;
providing those vendors which choose to respond by the deadline with computer-implemented means for responding with “response” communications containing substantive content presumptively responsive to the “request for bid” communication;
providing a data storage device and a computer-implemented process for writing data to the storage device in a form which is substantially un-editable by the requester;
providing the requester with a computer-implemented opening process to open the “response” communications including the substantive content thereof, without computer-implemented restraint thereto and without requester's discretion being subject to the control of any other party, whereby the requester's voluntary restraint is relied upon to assure requester doesn't open the substantive content until some time determined from the deadline;
providing the buyer with computer-implemented means for originating an informal message and utilities for broadcast transmission of, during the time period between origination of the “request for bid” communication and accessing the substantive content of any vendor's “response” communication, such informal message to all of the plurality of vendors whose respective contact data was known or otherwise supplied to the buyer previous to the instance of the broadcast transmission; and
providing a computer-implemented log process that operates automatically with the computer-implemented opening process that writes data comprising a log record to the storage device in the form that is substantially un-editable by the requester automatically with the requester's use of the computer-implemented opening process such that the requester's activity with opening at least the substantive content of the “response” communications is logged so that such log record can be audited after-the-fact to disclose if the requester voluntarily restrained itself from opening at least the substantive content of the “response” communications until the lapse of the some time determined from the deadline.

23. The method of claim 22, wherein:
the log process comprises providing an intermediary Internet resource to which the responding vendors commit the “response” communications, such that the intermediary Internet resource can log the requester's activity with at least the substantive content of the “response” communications so that such log record can thereafter disclose if the requester voluntarily restrained itself from opening at least the substantive content of the “response” communications until the lapse of some time determined from the deadline.

24. The method of claim 23, wherein:
the intermediary Internet resource comprises one or more Internet sites.

25. The method of claim 22, wherein:
the computer-implemented means for responding includes encrypting the “response” communications such that decryption requires access to a specific decryption key; and
the log process comprises providing a trusted party with said specific decryption key, such that said trusted party can log the requester's activity with said specific decryption key so that such log record can thereafter disclose if the requester voluntarily restrained itself from accessing said specific decryption key until the lapse of some time determined from the deadline.

26. The method of claim 25, wherein:
the trusted party comprises an intermediary Internet resource, which may include one or more Internet sites.

27. The method of claim 22, wherein:
the computer-implemented means for responding includes encoding or compressing the “response” communications such that decoding or decompressing requires access to a specific decoding or decompressing object; and
the log process comprises providing a trusted party with said decoding or decompressing object, such that said trusted party can log the requester activity with said decoding or decompressing object so that such log record can thereafter disclose if the requester voluntarily restrained itself from accessing said decoding or decompressing object until the lapse of some time determined from the deadline.

28. The method of claim 27, wherein:
decoding or decompressing objects can comprise any of passwords, algorithms, or hyper-link branches to an Internet address.

29. The method of claim 22, wherein:
wherein the log record is committed to machines of the requester's at the instance(s) of the requester's opening activities with respect to the “response” communications such that the log record is undesirably vulnerable to unauthorized deletion, corruption or other manipulation.

30. The method of claim 22, wherein:
the “request for bid” communication is contained in one or more web pages.

31. The method of claim 22, wherein:
the lapse of some time determined from the deadline means a time concurrent with or later than the deadline.
